(19) United States
(12) Patent Application Publication
(10) Pub. No.: US 2025/0059043 A1
(43) Pub. Date: Feb. 20, 2025

(54) A PROCESS FOR THE PREPARATION OF A SUPPORTED CARBON MEMBRANES (CMS)

(71) Applicants: TECHNISCHE UNIVERSITEIT EINDHOVEN, Eindhoven (NL); FUNDACION TECNALIA RESEARCH & INNOVATION, DERIO - BIZKAIA (ES)

(72) Inventors: Arash RAHIMALIMAMAGHANI, Eindhoven (NL); Fausto GALLUCCI, Eindhoven (NL); David Alfredo PACHECO TANAKA, Eindhoven (NL); Margot Anabell LLOSA TANCO, Eindhoven (NL)

(21) Appl. No.: 18/720,207

(22) PCT Filed: Dec. 13, 2022
(86) PCT No.: PCT/NL2022/050716

§ 371 Date: Jun. 14, 2024

(30) Foreign Application Priority Data
Dec. 17, 2021 (NL) 2030180

(51) Int. Cl. C01B 32/05; B01D 53/22; B01D 67/00; B01D 69/10; B01D 71/02; C01B 3/50; C04B 41/00; C04B 41/45; C04B 41/50; C04B 41/87

(52) U.S. Cl. CPC C01B 32/05; B01D 53/228; B01D 67/0067; B01D 69/108; B01D 71/021; C01B 3/503; C04B 41/0072; C04B 41/009; C04B 41/4539; C04B 41/5001; C04B 41/87; B01D 2256/16; B01D 2257/102; B01D 2323/081; B01D 2323/22; C01B 2203/0405; C01B 2203/0465

(57) ABSTRACT

The present invention relates to a process for the preparation of a supported Carbon Membranes (CMS). The present invention also relates to a process for the separation of a gas from a gas mixture and to the use of use of a supported CMs as a membrane reactor or in a membrane reactor.

### DESCRIPTION

The present invention relates to a process for the preparation of a supported Carbon Membranes (CMs). The present invention also relates to a process for the separation of a gas from a gas mixture and to the use of a supported CMs in the membrane reactor and as a membrane reactor.

Traditional separation methods such as distillation remain the main processing technology which accounts for 10-15% of the world's energy consumption. Non-thermal driven separation methods such as membranes offers higher efficiency in terms of energy consumption, scalability, smaller footprint, and lower impact on environment. While polymeric membranes are a mature technology in water purification, in gas separation, they are still in development stage, they have limitations that should be overcome such as: a) they are rarely deployed in applications exceeding 100° C. sue to their lack of stability at high temperatures which are important in processes such as precombustion CO2 capture, separation of hydrogen during the steam reforming from natural gas, separation of water gas during the CO₂ hydrogenation for the synthesis of Methanol, dimethyl ether (DME) b) Polymeric membranes are prone to plasticization (swelling and subsequent loss of permeation properties) such as in olefin/paraffin separation, benzene derivatives from each other, c) chemical and biochemical degradation, d) they are subject to a trade-off between permeability and selectivity; highly permeable membranes have low selectivity and vice versa; known as Robeson limit.

Carbon membranes (CMs) are product of the carbonization of thermosetting polymers in a non-oxidant environment. CMs are stable at high temperatures, chemically and biochemically more inert, do not suffer plasticization and can surpass the Robeson limit. CMs have two mechanisms for gas separation: molecular sieving in which the gases smaller than the pores passes, and adsorption diffusion which depend in the interaction of the molecules with the pores. The pore size, pore size distribution and adsorption properties of the membrane can be modulated changing the polymer precursor, temperature and time of carbonization and addition of inorganic nanoparticles. The permeation flow rate depends on the thickness of the membrane; therefore, thinner membranes are desired. However, standing alone thin (<50 μm thick) CMs are not mechanically strong, therefore, CMs supported on porous supports are required.

US 2021/138407 discloses a method of making a supported carbon molecular sieve membrane, the method comprising: contacting a film of a carbon forming polymer with a polymer textile to form a laminate, the film and polymer textile being comprised of a polymer selected from the group consisting of a polyvinylidene chloride copolymer, polyimide, or combination thereof, heating the laminate to a carbonization temperature for a time under an atmosphere sufficient to carbonize the film and polymer textile to form the supported carbon molecular sieve membrane comprised of a separating carbon layer supported on a carbon textile layer.

US 2021/129085 relates to a method of making a carbon molecular sieve membrane comprising, providing a precursor polymer, heating the precursor polymer to a pyrolysis temperature where the precursor polymer undergoes pyrolysis to form the carbon molecular sieve membrane, cooling the carbon molecular sieve membrane to a cooling temperature less than or equal to 50° C., and (iv) after the cooling, heating the carbon molecular sieve membrane to a reheating temperature of at least 250° C. to at most 400° C. for a reheating time from 15 minutes to 48 hours under a reheating atmosphere and then (v) cooling back to below 50° C.

CN109351202 relates to a method for preparing composite carbon membranes on basis of ceramic tubes used as supports.

KR20160034881 relates to a method for manufacturing a hydrogen separation membrane, the method comprising: forming a porous support; forming a hydrogen separation layer on the porous support; and thin film pressing to remove surface pores of the hydrogen separation layer to form a dense hydrogen separation layer and to improve hydrogen selectivity.

A publication written by A. B. Fuertes et al: “Carbon molecular 1-16 sieve membranes from polyetherimide”, MICROPOROUS AND MESOPOROUS MATERIALS, ELSEVIER, AMSTERDAM, NL, Vol 26, nr. 1-3, 16 Dec. 1998, relates to a carbon molecular sieve membrane with a high gas permselectivity for permanent gas pairs (O₂—N₂, N₂—He, CO₂—CH₄) obtained by carbonization of a commercial polyimide (polyetherimide). The membrane is obtained in only one casting step, and it is constituted by a thin microporous carbon film of around 3 μm in thickness which is supported on a macroporous carbon substrate.

A publication written by Hang Zheng Chen et al: “Multi-layer composite hollow fiber membranes derived from poly (ethylene glycol) (PEG) containing hybrid materials for CO/N separation”, JOURNAL OF MEMBRANE SCIENCE, ELSEVIER BV, Vol 381, nr. 1, 17 Jul. 2011 (2011-07-17), pages 211-220, relates to multi-layer composite hollow fiber membranes designed by surface coating ultrathin layers of a poly (ethylene glycol) (PEG) containing hybrid material onto the polyethersulfone (PES) porous substrate for CO₂/N₂ separation. The asymmetric PES hollow fiber substrate was prepared by a dry-jet wet spinning process and multiple ultrathin layers of the PEG containing hybrid polymer were then coated onto the substrate by continuous coating equipment.

A publication written by A. K. Itta et al: “Effect of dry/wet-phase inversion method on fabricating polyetherimide-derived CMS membrane for H₂/N₂ separation”, INTERNATIONAL JOURNAL OF HYDROGEN ENERGY, ELSEVIER, AMSTERDAM, NL, Vol 35, nr. 4, 1 Feb. 2010 (2010-02-01), pages 1650-1658 relates to carbon molecular sieve (CMS) membranes prepared through the dry/wet phase inversion method from the casting polyetherimide (PEI) on alumina support for hydrogen separation, wherein different coating techniques such as dry method and wet method at different pyrolysis temperatures were investigated.

U.S. Pat. No. 4,840,819 relates to a process of preparing a composite membrane capable of selectively permeating a more readily permeable component of a gas mixture in gas separation operations comprising: coating a porous support layer with a wet separation layer of membrane material, the support layer containing a controlled amount of liquid in the range of from about 10% to about 90% by weight of the liquid present in the support layer in fully wet form, the liquid being a solvent or non-solvent for the material of the separation layer; and drying the separation layer on the porous support layer, the presence of the liquid in the porous support layer precluding any appreciable penetration of the membrane material into the pores of the porous support layer, the separation layer thereby being of a non-occlusive nature with enhanced permeation characteristics, and having thickness of about 0.4 microns or less.

US 2011/030559 relates to a process for preparing a composite membrane comprising applying a curable composition to a porous support layer having a specific CO₂ gas flux, and curing the composition, thereby forming a discriminating layer on the porous support layer, wherein the curable composition comprises non-volatile and optionally volatile components and at least 60 wt. % of the non-volatile components are oxyethylene groups, wherein the curable composition is applied continuously to the porous support layer by means of a manufacturing unit comprising a curable composition application station, an irradiation source, a composite membrane collecting station and a means for moving a porous support layer from the curable composition application station to the irradiation source and to the composite membrane collecting station.

US 2018/133659 relates to a method of fabricating a carbon molecular sieve membrane for industrial gas separations, the method comprising providing a porous support structure including a first major surface opposite a second major surface and defining a thickness therebetween, forming an intermediate layer comprising an inorganic oxide on the first major surface of the porous support structure, forming a polymer precursor film on a surface of the intermediate layer opposite the porous support structure, the polymer precursor film having a thickness of less than 4 μm, and carbonizing the polymer precursor film in an inert atmosphere between 400° C. and 750° C. to form a carbon separating layer having a thickness of less than 1 μm.

US 2014/199478 relates to a method of producing a carbon membrane, comprising dipping a porous support in a suspension of a phenolic resin or a suspension of a phenolic resin precursor, drying the resulting support to form thereon a membrane made of the phenolic resin or the phenolic resin precursor, and heat treating and thereby carbonizing the membrane into a carbon membrane, wherein the phenolic resin or the phenolic resin precursor is a powdery substance.

An objective of the present invention is to increase the performance of CMs in terms of selectivity and permeability which will make the CMs considerable candidates for industrial gas separations and application such as a) H₂ separation in: the production of H₂, production of olefines from paraffins by dehydrogenation, transport and storage of H₂ in gas grids; b) separation of CO₂ in biogas upgrading, post combustion c) removal of water gas in: CO₂ reduction with H₂ for the production of methanol, DME, CH₄, solvent dehydration, d) separation of olefines from paraffins. The present invention thus relates to a process for the preparation of a supported CMs comprising the following steps:
a) providing a porous support;
b) providing a coating solution containing a polymeric carbon precursor;
c) providing a non-solvent in which the polymeric carbon precursor of b) has a low solubility;
d) contacting the porous support of a) with the non-solvent of c) and removing the excess non-solvent from the surface of support a) to form a solvent treated support;
e) coating the solvent treated support of d) with the coating solution of b);
f) drying the coated support of e);
g) carbonizing the dried coated support of f) for obtaining the supported carbon membranes (CMs).

On basis of the above process the present object is achieved. In addition, the present inventors found several benefits of the present process, such as ultra-thin and uniform top selective layer with an ultra-low resistance for gas permeation due to obtained structure, high permeability due to high porosity in the layer and no intrusion of the layer in the support, chemical and mechanical stability at high pressures and temperatures, a stable performance in presence of CO and a stable performance in long-term permeation test. In addition, the present inventors found that due to the single layer selective layer there is no requirement for additional layers to increase the selectivity.

In an example the porous support is chosen from the group of inorganic support.

In an example inorganic supports are ceramic metal oxide, nitride, boride, carbon or carbide, preferably chosen from the group of alpha alumina, titanium oxide, zirconium oxide, ceria, gamma alumina, silicon carbide.

In another example the porous support is a porous metallic support selected from the group of stainless steel and Inconel.

In an example, the porous support is tubular

In an example, the selective layer is deposited in the outside of the tubular support.

In an example the coating solution of b) is prepared by a thermosetting polymer carbon precursor, such as Novolac oligomers, wherein the thermosetting polymer precursor is dissolved in an organic solvent, such as N-methyl pyrrolidone.

In an example step d) is carried out in such a way that the pores of the porous support of a) are filled with the non-solvent of c), wherein step d) is preferably carried out by immersing the porous support of a) in the non-solvent of c). In step d) the excess of non-solvent on the porous support is preferably removed by an adsorbent cloth.

In an example step g) of carbonizing is carried out under an inert atmosphere or vacuum, wherein in step g) the carbonization temperature is from 350° C. to 1100° C., particularly from 450° C. to 900° C., more preferably from 500° C. to 850° C.

In an example, the carbonization pressure in step g) ranges from 2 mbar to 6 bar with multiple gases such as N2, He, Ar and air.

The present invention also relates to a supported CM comprising a selective layer on the outer surface of the porous support.

The present invention also relates to a process for the separation of a gas from a gas mixture, the process comprising:
providing a supported CM as mentioned above or a supported CM obtained according to the present method for the preparation of a supported CM;
providing a gas mixture comprising at least two gases; and feeding the gas mixture to the supported CM at a temperature from 5° C. to 600° C. in order to obtain a retentate and a permeate.

In an example the at least two gases are selected from but not limited to He, H₂O, Ne, H₂, NO, Ar, NH₃, N₂, O₂, CO, CO₂, CH₄, C₂H₄, C₂H₆, propene, propane, H₂S, methanol, ethanol, DME, 1-2 propanol and 1-2 butanol, especially wherein the gas mixture comprises at least two gases selected from the group consisting of H₂/CH₄, H₂/N₂, H₂/O₂, CO₂/CH₄, CO₂/N₂, and O₂/N₂.

The present invention also relates to the use of a supported CM as mentioned above or a supported CM obtained according to the present method for the preparation of a supported CM as a membrane reactor or in a membrane reactor.

In a specific embodiment, tubular supported CMs are fabricated from phenol-formaldehyde resin (Novolac) with dip-dry carbonization method. The present method of fabrication includes the blockage of the pores on the surface of the alumina support with a condensable liquid to fabricate CM selective layer only on the surface of the support and prevent from the diffusion of the dipping solution in the pores of the support.

CMs are synthesized from pyrolysis of a thermosetting polymer such as Novolac between temperatures 350-1100° C. The amorphous carbon skeleton after pyrolysis is a porous media which the pore size could be tuned according to the polymer properties and carbonization conditions.

Porous supports are used to increase the mechanical stability of CMs. Alpha alumina, titanium oxide, zirconium oxide and gamma alumina are the most used supports in fabrication of CMs. The thermal expansion coefficient of support should be close to the CM to prevent from emerging cracks while heating or cooling down. The performance of the fabricated CM is analysed using permeation tests at multiple pressures and temperatures with single gases such as H₂ and N₂. The ideal gas selectivities are calculated based on the permeances of single gases through the membrane.

Scanning Electron Microscopy (SEM) is used to measure the thickness of the top selective layer in CMs and to calculate the gas permeabilities. Finally, for the comparison of performance with organic and inorganic membranes, the Robeson's upper bound graph is used as a benchmark. For comparative purposes, CM without the use of the non-solvent in the pores were prepared; in this case, the polymer will fill the pores of the support that after carbonization carbon will be produced (Pore filled CM).

Schematic 1 illustrates a SEM schematic from the ultra-selective CM with a top selective layer.

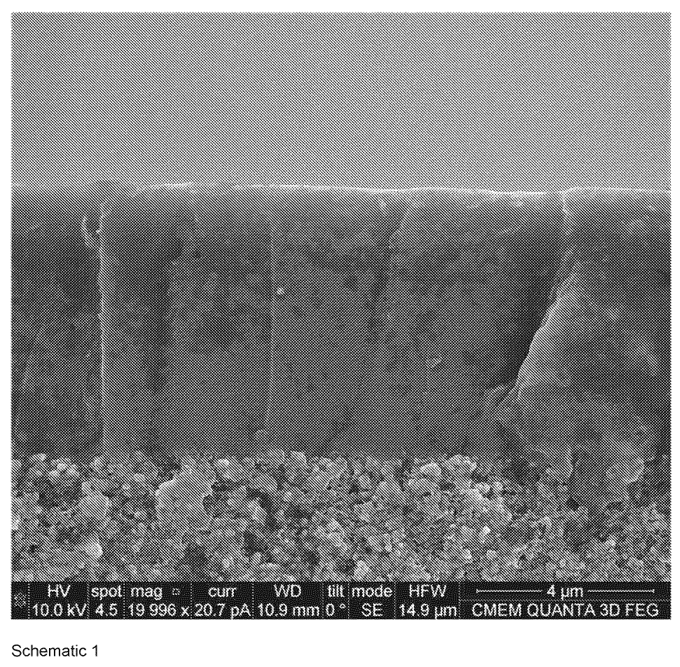

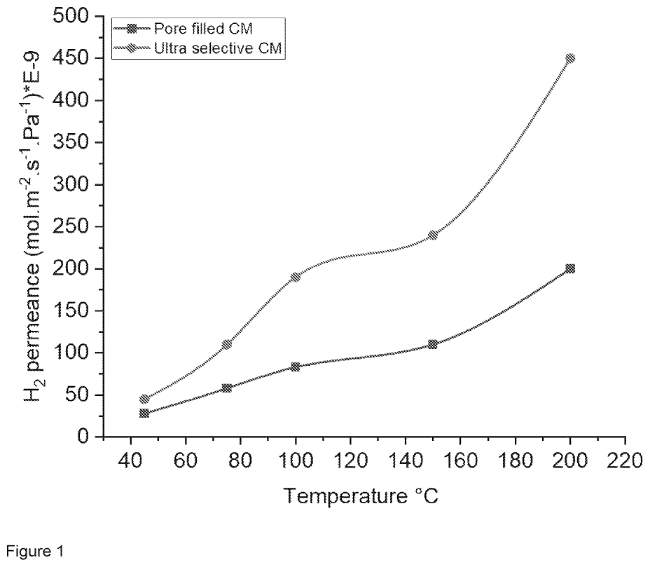

FIG. 1 illustrates the H₂ permeances for membranes fabricated with ultra-selective CM and Pore filled CM at multiple temperatures.

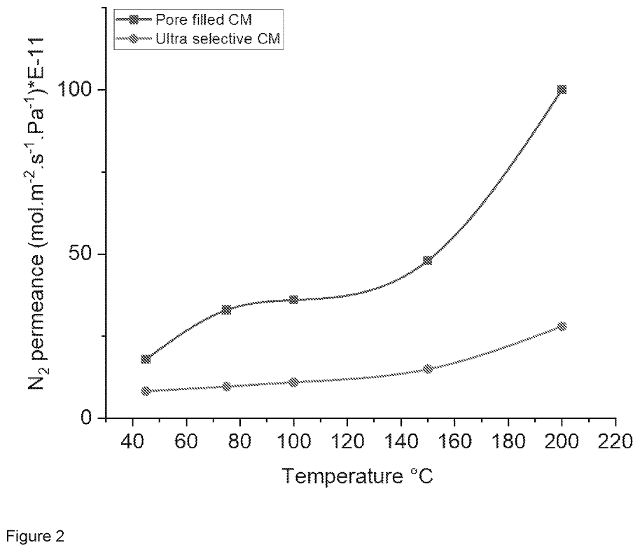

FIG. 2 illustrates the N₂ permeances for membranes fabricated with ultra-selective CM and Pore filled CM at multiple temperatures.

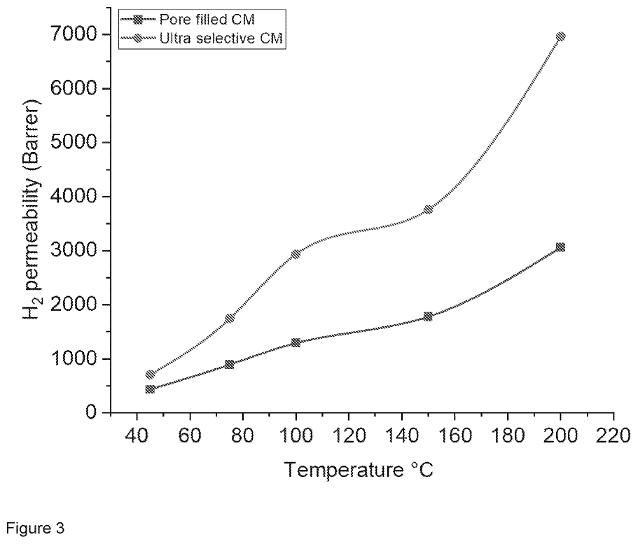

FIG. 3 illustrates the H₂ permeabilities for membranes fabricated with ultra-selective CM and Pore filled CM at multiple temperatures.

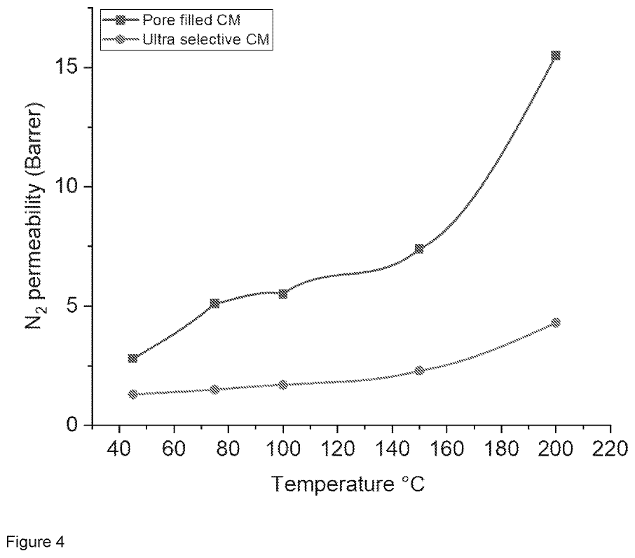

FIG. 4 illustrates the N₂ permeabilities for membranes fabricated with ultra-selective CM and Pore filled CM at multiple temperatures.

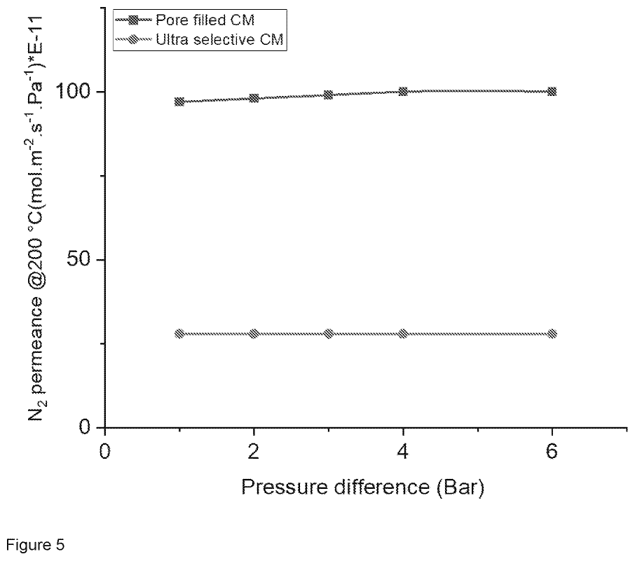

FIG. 5 illustrates the N₂ permeances for membranes fabricated with ultra-selective CM and Pore filled CM at multiple pressure differences at 200° C.

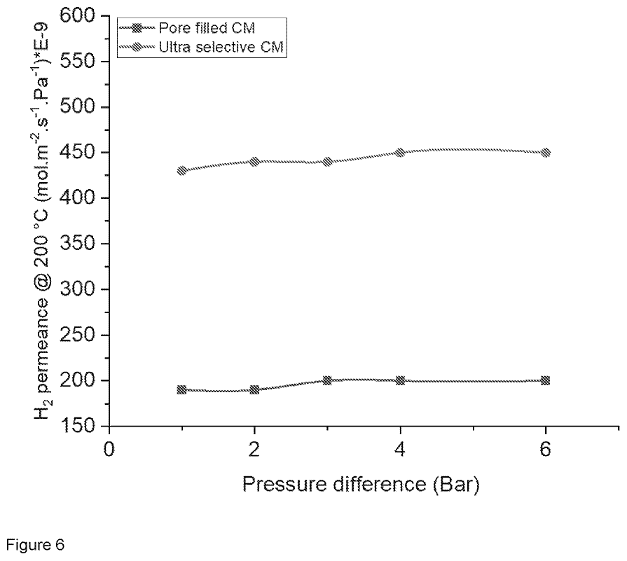

FIG. 6 illustrates the H₂ permeances for membranes fabricated with ultra-selective CM and Pore filled CM at multiple pressure differences at 200° C.

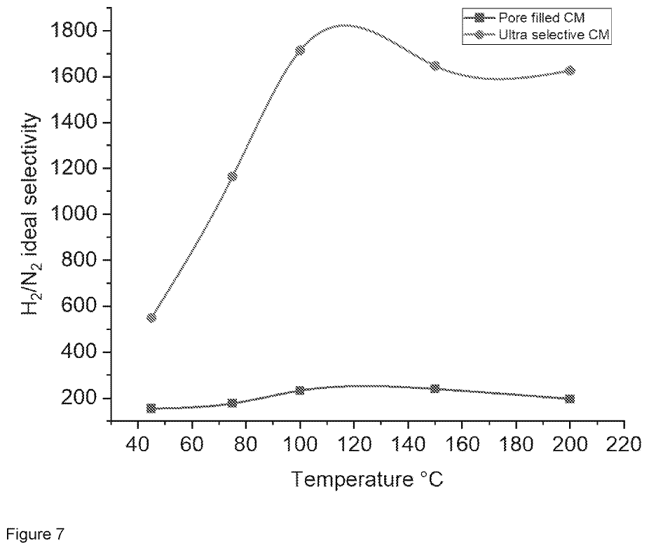

FIG. 7 illustrates the comparison in H₂/N₂ ideal selectivity for membranes fabricated with ultra-selective CM and Pore filled CM.

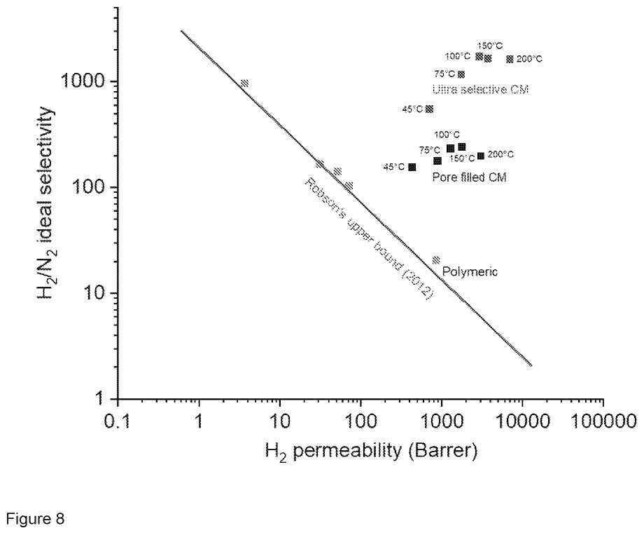

FIG. 8 indicates the comparison between CMSMs and Robeson's upper bound limit for the H₂/N₂ selectivity vs, H₂ permeability for polymeric membranes.

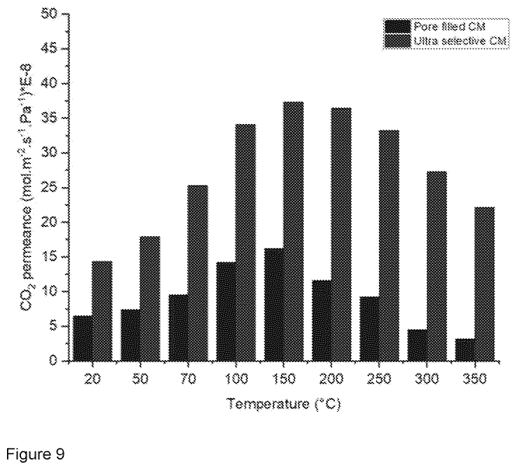

FIG. 9 indicates the comparison of CO₂ permeance in pore filled CM to ultra-selective CM.

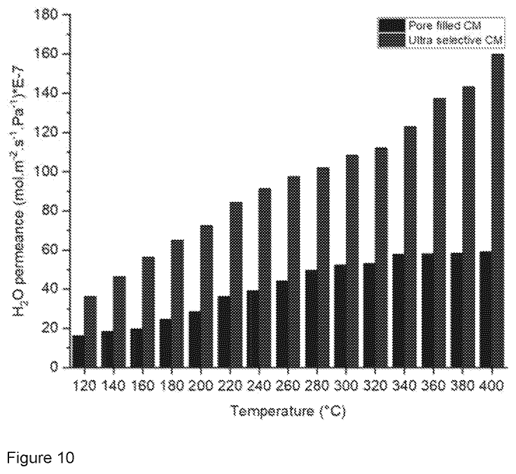

FIG. 10 indicates the comparison of H₂O permeance in pore filled CM to ultra-selective CM as a function of temperature.

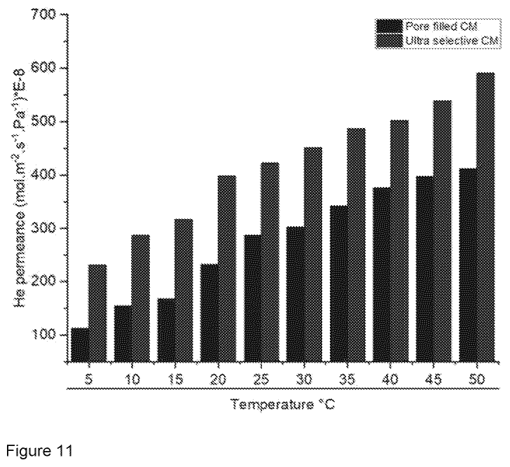

FIG. 11 indicates the comparison of He permeance in pore filled CM to ultra-selective CM as a function of temperature.

### EXAMPLES

The precursor is synthesized from polycondensation of formaldehyde with phenol in acidic media to form Novolac oligomers. The process starts with melting 32 g of phenol at 50° C. in a round bottom three neck glass vessel. In the next step 0.5 g of oxalic acid is added to the solution. In the final step the temperature increased to 85° C. and the 23 g of formaldehyde (37 wt. %) is added to the solution and reacted for 3 hr. The dipping solution is made by dissolving Novolac oligomer in an organic solvent such as N-Methyl-2-pyrrolidone. In the next step, the tubular alpha alumina supports (10 mm 7 mm external internal diameter). One end was closed and both end surfaces were sealed with glass to glass leaving xx cm of effective membrane length. The porous support was immersed in a non-solvent to fill the pores with the solution. The excess non-solvent present on the surface is removed by adsorbent paper. Then, the supports are dip coated with a custom-made dipping machine with the prepared polymeric solution. After the dip coating, the coated supports are moved to the rotary drying oven and are dried for 24 hr at 80° C. In the final step, the coated supports are moved to carbonization oven and carbonized under inert atmosphere at 600° C.

After carbonization, the membrane is used in a permeation device for testing. Due to the existing of water-based solution in the pores of the support, it will prevent the polymer to diffuse inside of the support, as the polymer is not soluble in the non-solvent, the polymer will precipitate on the mouth of the pores. This phenomenon results in a thin top selective layer CM in a single dip-dry-carbonization step. If the non-solvent is not clogging the pores, the dipping solution containing the polymer will diffuse into the pores, and after carbonization, the pore size will be reduced producing high resistance to the passage of the permeated gases. In addition, several dip carbonization steps will be required to form a continuous defect free selective layer.

After carbonization, the membrane is used in permeation cell for testing. Due to the existing of water-based solution in the pores of the support, it will prevent from the dipping solution to diffuse inside of the support. This phenomenon results in a top selective layer CM.

The single gas permeation tests are carried out in range of 1-6 pressure difference between permeate and retentate in temperature range of 45-200° C. The ideal gas selectivity was calculated based on the permeances of H₂ and N₂ through the membrane and the ratio of them is considered as the ideal selectivity. FIG. 7 illustrates the comparison in H₂/N₂ ideal selectivity for membranes fabricated with ultra-selective CM and Pore filled CM.

The permeance measurements of H₂ at temperatures between 45-200° C. were performed in pressures differences of 1-6 bar between permeate and retentate streams. FIGS. 3 and 4 shows the effect of the present method in the performance of CMs in terms of H₂ and N₂ permeabilities vs. temperature.

To analyse the existing defect in the CMs, the multiple pressure difference tests are performed on the CMs and as it could be seen in FIGS. 5 and 6, both ultra-selective and pore filled CMs, do not contain any defects due to the zero slope in H₂ and N₂ permeances vs pressure.

In this method both selectivity and permeability of the CMs were enhanced, and the membrane separation technology will be competitive to separate and purify gases such as H₂ in an industrial scale in ammonia production, power generation and metal refineries. FIG. 8 indicates the comparison between CMs and Robeson's upper bound limit for the H₂/N₂ selectivity vs, H₂ permeability for polymeric membranes.

In benchmarking CMs performance with the performance of polymeric membranes upper bound limit, both pore filled and ultra-selective CMs perform higher than polymeric membranes in terms of H₂/N₂ selectivity and H₂ permeability. Ultra-selective CMs, further exhibit higher performance at the same operational conditions such as pressure and temperature against the pore filled CMSMs. Characteristics of the present ultra-selective CMs include i) ultra-thin and defect free selective layer, ii) extremely high permeability with high selectivity, iii) blocking support pores to prevent diffusion, and iv) top selective layer membrane instead of pore filled membrane.

The present method of fabrication (ultra-selective) of Carbon Membranes (CMs) was investigated and compared to pore filled CMSMs in multiple separation processes.

The method was tested for separation of CO₂ from CH₄ as an application for natural gas purification and steam reforming. The permeance of CMs, fabricated with the present method, was compared to pore filled membranes as shown in FIG. 9:

As seen in FIG. 9, the ultra-selective CM which was fabricated with the present method, represented higher CO₂ permeance at operational temperatures ranging from 20 to 350° C. Higher CO₂ permeance in new membranes offers the potential of this innovation in adapting the CM to industrial applications such as CO₂ removal from post combustion with lowering the separation required surface area.

In another study of superior performance of ultra-selective CMs, separation of water in reaction conditions was investigated and H₂O permeance in pore filled CMs was compared to novel CMs. Water is produced as a by-product in numerous reactions such as methanol synthesis in industries. In-situ separation of water from reaction environment can increase the production of desired product such as methanol due to shifting the equilibrium based on Le Chatelier's effect. Increasing the H₂O permeance in the membranes which are developed to operate at temperatures up to 400° C., enables integration of separation and reaction in one unit, resulting enhancing the yield of process. Present ultra-selective CMs fabrication was performed on enhancing the H₂O permeance at high operational temperatures. The results of this study was summarized in FIG. 10. As it is indicated by FIG. 10, present CMs performed at all operating temperatures (120-400° C.) higher than pore filled CMs in terms of H₂O permeance.

Due to superior control of pore size distribution and selective layer thickness in novel method compared to pore filled CMs, the improvement of CMs performance in terms of permselectivity was carried out for helium gas separation from natural gas. Helium is the noble gas which is only produced from separation and purification process of natural gas. The USA is the main producer of helium in the world and due to the scarcity of this element and its crucial role in industries such as pharma, aerospace and health care, its price tripled in the past 6 years. Efficient separation of helium from methane could significantly reduce the final cost of pure helium and increase its production from lean gas wells with diluted concentrations of helium. CMs with narrow pore size distribution were produced with the present method and were tested for He permeation at low temperatures. FIG. 11 represents the performance of CMs in terms of helium permeance as a function of temperature. Ultra-selective CMs reached 398 mol·m−2·s−1·Pa−1·e−8 helium permeance at 20° C. operational temperature while the pore filled membrane represented only 232 mol·m−2·s−1·Pa−1·e−8 helium permeance. Higher helium permeance will reduce the required surface area resulting in lower CAPEX and OPEX for separation units.

The present invention could be used in industries that require pure gas production and purification such as CO₂ separation and utilization, hydrogen recovery from waste streams, hydrogen production, hydrogen purification, hydrogenation chemical reactions, dehydrogenation chemical reactions. Companies that my use the present invention include but not limited to ammonia production to purify and separate hydrogen from off gas, metal refineries to recover the hydrogen and CO from blast furnace, power plants for precombustion operation, petroleum refineries for hydrogenation of heavy oil, petrochemical plants for dehydrogenation in production of polymers, biorefineries for hydrogenation, and bio syngas production to purify and recover hydrogen and CO. Separation of He from natural gas, natural gas sweetening, biogas upgrading, H₂S separation from biogas, and N₂ separation from natural gas.

1-16. (canceled)

17. A process for the preparation of a supported carbon membrane (CM), the process comprising the steps of:
providing a porous support;
providing a coating solution containing a polymeric carbon precursor;
providing a non-solvent in which the polymeric carbon precursor has a low solubility;
contacting the porous support with the non-solvent and removing the excess non-solvent from the surface of the porous support to form a solvent treated support;
coating the solvent treated support with the coating solution;
drying the coated support; and
carbonizing the dried coated support to obtain a supported carbon membrane (CM).

18. The process according to claim 17, wherein the porous support is an inorganic support.

19. The process according to claim 17, wherein the porous support is ceramic based on a metal oxide, nitride, boride, carbon, or carbide.

20. The process according to claim 17, wherein the porous support is selected from the group including alpha alumina, titanium oxide, zirconium oxide, ceria, and gamma alumina silicon carbide.

21. The process according to claim 17, wherein the porous support is metallic selected from the group including steel, stainless steel, and Inconel.

22. The process according to claim 17, wherein the coating solution is prepared by a thermosetting polymer carbon precursor, and wherein the thermosetting polymer precursor is dissolved in an organic solvent.

23. The process according to claim 22, wherein the thermosetting polymer carbon precursor is a Novolac oligomer, and the organic solvent is N-methyl pyrrolidone.

24. The process according to claim 17, wherein the step of contacting the porous support with the non-solvent and removing the excess non-solvent from the surface of the porous support to form the solvent treated support includes filling pores of the porous support with the non-solvent.

25. The process according to claim 17, wherein the step of contacting the porous support with the non-solvent and removing the excess non-solvent from the surface of the porous support to form the solvent treated support includes immersing the porous support in the non-solvent.

26. The process according to claim 17, wherein the step of contacting the porous support with the non-solvent and removing the excess non-solvent from the surface of the porous support to form the solvent treated support includes removing the excess non-solvent with an adsorbent cloth.

27. The process according to claim 17, wherein the step of carbonizing the dried coated support to obtain the supported carbon membrane (CM) s is performed under an inert atmosphere or vacuum.

28. The process according to claim 17, wherein the step of carbonizing the dried coated support to obtain the supported carbon membrane (CM) is performed at a carbonization temperature from 350° C. to 1100° C.

29. The process according to claim 17, wherein the step of carbonizing the dried coated support to obtain the supported carbon membrane (CM) is performed at a carbonization temperature from 500° C. to 850° C.

30. The process according to claim 17, wherein the step of carbonizing the dried coated support to obtain the supported carbon membrane (CM) is performed at a carbonization pressure in a range from 2 mbar to 6 bar and with gas including at least one of N₂, He, Ar, and air.

31. The process according to claim 17, wherein the obtained supported carbon membrane (CM) is used as a membrane reactor or in a membrane reactor.

32. The process according to claim 17, wherein the obtained supported carbon membrane (CM) is used in at least one of industrial gas separation to separate H₂, produce olefines from paraffins by dehydrogenation, transport and store H₂ in gas grids, separate CO₂ in biogas upgrading, post combustion, removal of water gas in CO₂ reduction with H₂ for the production of methanol, DME, CH₄, solvent dehydration, and separate olefines from paraffins.

33. A process for separating a gas from a gas mixture, the process comprising the steps of:
providing a supported carbon membrane (CM) obtained according to claim 17;
providing a gas mixture comprising at least two gases; and
feeding the gas mixture to the supported carbon membrane (CM) at a temperature from 5° C. to 600° C. to obtain a retentate and a permeate.

34. The process according to claim 33, wherein the at least two gases are selected from the group including He, H₂O, Ne, H₂, NO, Ar, NH₃, N₂, O₂, CO, CO₂, CH₄, C₂H₄, C₂H₆, propene, propane, H₂S, methanol, ethanol, DME, 1-2 propanol and 1-2 butanol.

35. The process according to claim 33, wherein the gas mixture is selected from the group including He/CH₄, H₂S/CH₄, H₂/CH₄, H₂/N₂, H₂/CO₂, CO₂/CH₄, CO₂/N₂, and O₂/N₂.
